(19) United States
(12) Patent Application Publication
(10) Pub. No.: US 2008/0273708 A1
(43) Pub. Date: Nov. 6, 2008

(54) Early Reflection Method for Enhanced Externalization

(75) Inventors: Patrik Sandgren, Stockholm (SE); Anders Eriksson, Uppsala (SE); Erlendur Karlsson, Uppsala (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/744,111

(22) Filed: May 3, 2007

(51) Int. Cl. G10K 15/08

(52) U.S. Cl. 381/63

(57) ABSTRACT

Scenes having at least one simulated sound source and simulated sound-reflecting objects are simulated by processing a direct-sound signal with at least one head-related transfer-function, thereby generating a simulated direct-sound signal, and generating simulated early-reflection signals from the simulated direct-sound signal, including simulating early reflections having incidence angles different from the incidence angle of the direct-sound signal. Externalization of the simulated sound source is enhanced.

### BACKGROUND

This invention relates to electronic creation of virtual three-dimensional (3D) audio scenes and more particularly to increasing the externalization of virtual sound sources presented through earphones.

When an object in a room produces sound, a sound wave expands outward from the source and impinges on walls, desks, chairs, and other objects that absorb and reflect different amounts of the sound energy. FIG. 1 depicts an example of such an arrangement, and shows a sound source 100, three reflecting/absorbing objects 102, 104, 106, and a listener 108.

Sound energy that travels a linear path directly from the source 100 to the listener 108 without reflection reaches the listener earliest and is called the direct sound (indicated in FIG. 1 by the solid line). The direct sound is the primary cue used by the listener to determine the direction to the sound source 100.

A short period of time after the direct sound, sound waves that have been reflected once or a few times from nearby objects 102, 104, 106 (indicated in FIG. 1 by dashed lines) reach the listener 108. Reflected sound energy reaching the listener is generally called reverberation. The early-arriving reflections are highly dependent on the positions of the sound source and the listener and are called the early reverberation, or early reflections. After the early reflections, the listener is reached by a dense collection of reflections called the late reverberation. The intensity of the late reverberation is relatively independent of the locations of the listener and objects and varies little in a room.

A room's reverberation depends on various properties of the room, e.g., the room's size, the materials of its walls, and the types of objects present in the room. Measuring a room's reverberation usually involves measuring the transfer function from a source to a receiver, resulting in an impulse response for the specific room. FIG. 2 depicts a simplified impulse response, called a reflectogram, with sound level, or intensity, shown on the vertical axis and time on the horizontal axis. In FIG. 2, the direct sound and early reflections are shown as separate impulses. The late reverberation is shown as a solid curve in FIG. 2, but the late reverberation is in fact a dense collection of impulses. An important parameter of a room's reverberation is the reverberation time, which usually is defined as the time it takes for the room's impulse response to decay by 60 dB from its initial value. Typical values of reverberation time are a few hundred milliseconds (ms) for small rooms and several seconds for large rooms, such as concert halls and aircraft hangars. The length (duration) of the early reflections varies also, but after about 30-50 ms, the separate impulses in a room's impulse response are usually dense enough to be called the late reverberation.

In creating a realistic 3D audio scene, or in other words simulating a 3D audio environment, it is not enough to concentrate on the direct sound. Simulating only the direct sound mainly gives a listener a sense of the angle to the respective sound source but not the distance to it. Simulating reverberation is also important as reverberation changes the loudness, timbre, and the spatial characteristics of sounds and can give a listener different kinds of information about a room, e.g., the room's size and whether it has hard or soft reflective surfaces.

The ratio between reflected energy and direct energy is known to be an important cue for distance perception. S. H. Nielsen, “Auditory Distance Perception in Different Rooms”, Journal of the Audio Engineering Society, Vol. 41, No. 10 (October 1993) and D. R. Begault, “Perceptual Effects of Synthetic Reverberation on Three-Dimensional Audio Systems”, Journal of the Audio Engineering Society, Vol. 40, No. 11 (November 1992) show that anechoic sounds, i.e., sounds without reverberation, are perceived as emanating from sources located close to the listener and that including reverberation results in sound sources that are perceived as more distant.

The intensity of a sound source is another known distance cue, but in an anechoic environment, it is hard for a listener to discriminate between two sound sources at different distances that result in the same sound intensity at the listener. The only distance-related effect in an anechoic environment is the low-pass filtering effect of air between the source and the listener. This effect is significant, however, only for very large distances, and so it is usually not enough for a listener to judge which of two sound sources is farther away in common audio scenes.

In simulating an audio scene or creating a virtual audio scene, the sound sources' direct sounds are usually generated by filtering a monophonic sound source with two head-related transfer functions (HRTFs), one for each of left and right channels. These HRTFs, or filters, are usually determined from measurements made in an anechoic chamber, in which a loudspeaker is placed at different angles with respect to an artificial head, or a real person, having microphones in the ears. By measuring the transfer functions from the loudspeaker to the microphones, two filters are obtained that are unique for each particular angle of incidence. The HRTFs incorporate 3D audio cues that a listener would use to determine the position of the sound source. Interaural time difference (ITD) and interaural intensity difference (IID) are two such cues. An ITD is the difference of the arrival times of a sound at a listener's ears, and an IID is the difference of the intensities of a sound arriving at the ears.

Besides ITD and IID, frequency-dependent effects caused primarily by the shapes of the head and ears are also important for perceiving the position(s) of sound source(s). Due to the absence of such frequency-dependent effects, a well known problem when listening to virtual audio scenes with headphones is that the sound sources appear to be internalized, i.e., located very close to a listener's head or even inside the head.

Having binaural impulse responses measured in a reverberant room can result in distance perception in a simulation of the room, but considering that a room's impulse response can be several seconds long, such measured binaural impulse responses are not a good choice with respect to memory and computational complexity, either or both of which can be limited, especially in portable electronic devices, such as mobile telephones, media (video and/or audio) players, etc. Instead, 3D audio scenes are usually simulated by combining anechoic HRTFs and computational methods of simulating the early and late reverberations.

M. R. Schroeder, “Digital Simulation of Sound Transmission in Reverberant Spaces”, The Journal of the Acoustical Society of America, Vol. 47, pp. 424-431 (1970) describes a 3D audio generator that uses an anechoic sound signal as input and generates simulated direct sound and early reflections with a tapped delay line, in which each tap simulates a direct or reflected sound wave. The late reverberation is simulated in a more statistical way by a reverberator having comb and all-pass filters. Respective gains applied to the tapped signals simulate attenuation due to distance and, for the early reflections, the absorption of sound that occurs during reflection. The gains can be made frequency-dependent in order to account for the spectral modifications that occur during reflection. Such spectral modifications are often realized with a low-pass filter.

J. A. Moorer, “About This Reverberation Business”, Computer Music Journal, Vol. 3, no. 2, pp. 13-28, MIT Press (Summer 1979) describes various enhancements to the reverberation generators described in the Schroeder publication, including a generator having a recirculating part that includes six comb filters in parallel and six associated first-order low-pass filters.

Tapped delay lines and their equivalents, such as finite-impulse-response (FIR) filters, are still commonly used today for simulating early reflections. The delay(s) and amplification parameters can be calculated using reflection calculation algorithms, such as ray tracing and image source methods, as described by, for example, A. Krokstad, S. Strøm, and S. Sørsdal, “Calculating the Acoustical Room Response by the Use of a Ray Tracing Technique”, Journal of Sound and Vibration 8, pp. 118-125 (1968) and J. B. Allen and D. A. Berkely, “Image Method for Efficiently Simulating Small-Room Acoustics”, The Journal of the Acoustical Society of America, Vol. 65, pp. 943-950 (April 1979).

U.S. Pat. No. 4,731,848 to Kendall et al. for “Spatial Reverberator” also describes a tapped delay line for creating the early reflections, but adds filtering to all taps with respective HRTFs in order to simulate angles of incidence. The delays and angles of incidence are calculated using an image source method. This arrangement is depicted in FIG. 3. The HRTFs H_{L,0}(z) and H_{R,0}(z) are associated with the direct sound, which is given a gain A₀(z), and the HRTFs H_{L,1}(z), H_{R,1}(z), H_{L,2}(z), H_{R,2}(z), . . . are associated with the early reflections that are given respective gains A₁(z), A₂(z), . . . The first early reflection depicted in FIG. 3 is delayed by z^{-m1} with respect to the direct sound, the second early reflection is delayed by a further z^{-m2}, etc. This generator can simulate early reverberation accurately, but applying HRTFs to the direct sound and all early reflections is costly with respect to the number of calculations required. In addition, the sound paths in a scene having moving sound sources change continually, and thus the corresponding HRTFs must be updated continually, which is also computationally costly.

J.-M. Jot, V. Larcher, and O. Warusfel, “Digital Signal Processing Issues in the Context of Binaural and Transaural Stereophony”, Audio Engineering Society Preprint 3980 (1995) describes a generator like that of U.S. Pat. No. 4,731,848 but in which the frequency-dependence part of the HRTFs for the reflections is removed and only the IID and ITD are kept. An average directional filter is applied to the sum of the early reflections and used to produce frequency-dependent features obtained by a weighted average of the various HRTFs and absorptive filters.

U.S. Pat. No. 4,817,149 to Myers for “Three-dimensional Auditory Display Apparatus and Method Utilizing Enhanced Bionic Emulation of Human Binaural Sound Localization” describes a generator like that of the Jot et al. Preprint, but instead of applying an average directional filter to the sum of the early reflections, band-pass filters are applied. By changing the band-pass frequencies, the resulting sound image can be broadened or made more or less diffuse. The Myers patent also describes that the reflections should be simulated to come from the extreme left and right of the listener in order to increase the externalization of the virtual sound sources.

D. Griesinger, “The Psychoacoustics of Apparent Source Width, Spaciousness and Envelopment in Performance Spaces”, Acoustica, Vol. 83, pp. 721-731 (1997) also proposes that the reflections should be lateralized as much as possible, i.e., the reflections should be simulated to come from the far left and far right of the listener.

International Patent Publication No. WO 02/25999 to Sibbald for “A Method of Audio Signal Processing for a Loudspeaker Located Close to an Ear” concentrates on the externalization of sound sources for earphones-based listening instead of on replicating room acoustics, and concludes that it is not the main reflections from the floor, ceiling, and walls of a room that result in externalization. Instead, other objects in the room, e.g., tables and chairs, that scatter sound waves are essential for good externalization. A generator is described, depicted in FIG. 4, in which respective scattering filters are applied to left and right channels of a direct-sound signal produced by an HRTF from a monophonic input source signal. The scattering filters are intended to simulate the effect of sound-wave scattering.

When several sound sources are present in an audio scene, using separate early-reflection simulators for each source can be computationally costly. U.S. Pat. No. 5,555,306 to Gerzon for “Audio Signal Processor Providing Simulated Source Distance Control” and No. 6,917,686 to Jot et al. for “Environmental Reverberation Processor” propose to direct a monophonic sound source to two separate channels. The first channel processes the direct sound, and the second channel, the reflection channel, is directed after delay and gain operations to a summing unit, which sums together all sources' reflection channels. The sum is directed to one early-reflection simulator.

Simulating the early reflections properly is important for achieving good externalization of virtual sound sources when listening through earphones. WO 02/25999 investigates how much a room's impulse response can be truncated without losing too much externalization, and concludes that the period from 5-30 ms after the direct sound's arrival cannot be removed and thus that the late reverberation has no or little impact on the externalization of virtual sound sources.

Attempts have been made to reduce the computational load imposed by the generators described above. The above-cited Preprint by Jot et al., U.S. patent to Myers, and paper by Griesinger all remove the unique HRTF filtering applied to each reflection and apply frequency-dependent features of the early reflections after all reflections have been summed together. This, however, results in that all reflections reaching a listener's ears have the same spectral content, which degrades the externalization and the sound quality. The same is true for WO 02/25999 that applies scattering filters to the HRTF-processed direct sound in order to simulate reflections coming from angles of arrival similar to the angle of arrival of the direct sound. WO 02/25999 also has the problem that the intensity of its simulated early reflections follows the intensity of the simulated direct sound if the scattering filters are kept constant, which is not realistic. Even if the scattering filters continually change, the result is not satisfactory.

### SUMMARY

In accordance with aspects of this invention, there is provided a method of generating signals that simulate early reflections of sound from at least one simulated sound-reflecting object. The method includes the steps of filtering a simulated direct-sound first-channel signal to form a first-direct filtered signal; filtering the simulated direct-sound first-channel signal to form a first-cross filtered signal; filtering a simulated direct-sound second-channel signal to form a second-cross filtered signal; filtering the simulated direct-sound second-channel signal to form a second-direct filtered signal; forming a simulated early-reflection first-channel signal from the first-direct and second-cross filtered signals; and forming a simulated early-reflection second-channel signal from the second-direct and first-cross filtered signals.

In accordance with further aspects of this invention, there is provided a generator configured to produce, from at least first- and second-channel signals, simulated early-reflection signals from a plurality of simulated sound-reflecting objects. The generator includes a first direct filter configured to form a first-direct filtered signal based on the first-channel signal; a first cross filter configured to form a first-cross filtered signal based on the first-channel signal; a second cross filter configured to form a second-cross filtered signal based on the second-channel signal; a second direct filter configured to form a second-direct filtered signal based on the second-channel signal; a first combiner configured to form a simulated early-reflection first-channel signal from the first-direct and second-cross filtered signals; and a second combiner configured to form a simulated early-reflection second-channel signal from the second-direct and first-cross filtered signals.

In accordance with further aspects of the invention, there is provided a computer-readable medium having stored instructions that, when executed by a computer, cause the computer to generate signals that simulate early reflections of sound from at least one simulated sound-reflecting object. The signals are generated by filtering a simulated direct-sound first-channel signal to form a first-direct filtered signal; filtering the simulated direct-sound first-channel signal to form a first-cross filtered signal; filtering a simulated direct-sound second-channel signal to form a second-cross filtered signal; filtering the simulated direct-sound second-channel signal to form a second-direct filtered signal; forming a simulated early-reflection first-channel signal from the first-direct and second-cross filtered signals; and forming a simulated early-reflection second-channel signal from the second-direct and first-cross filtered signals.

### BRIEF DESCRIPTION OF THE DRAWINGS

The various objects, features, and advantages of this invention will be understood by reading this description in conjunction with the drawings, in which:

FIG. 1 depicts an arrangement of a sound source, reflecting/absorbing objects, and a listener;

FIG. 2 depicts a reflectogram of an audio environment;

FIG. 3 depicts a known 3D audio generator that consists of a tapped delay line with head-related-transfer-function filters and gains applied to the taps;

FIG. 4 depicts a known 3D audio generator having wave scattering filters that are applied to filtered direct sound;

FIG. 5A is a block diagram of an audio simulator having HRTF processors and an early-reflection generator;

FIG. 5B is a block diagram of another embodiment of an audio simulator having HRTF processors and an early-reflection generator;

FIG. 5C is a block diagram of another embodiment of an audio simulator having HRTF processors, an early-reflection generator, and a late-reverberation generator;

FIG. 6A is a block diagram of an early-reflection generator using cross-coupling;

FIG. 6B is a block diagram of an early-reflection generator using cross-coupling and attenuation filters;

FIG. 6C is a block diagram of an early-reflection generator using cross-coupling of an arbitrary number of channels;

FIG. 7A is a flow chart of a method of simulating a three-dimensional sound scene;

FIG. 7B is a flow chart of a method of generating simulated early-reflection signals;

FIG. 8 is a block diagram of a user equipment;

FIG. 9 shows spectra of actual and approximated left HRTFs for 25 degrees;

FIG. 10 shows spectra of actual and approximated right HRTFs for 25 degrees;

FIG. 11 shows spectra of actual and approximated left HRTFs for −20 degrees;

FIG. 12 shows spectra of actual and approximated right HRTFs for −20 degrees;

FIG. 13 shows spectra of actual and approximated left HRTFs for −20 degrees using the right HRTF of direct sound; and

FIG. 14 shows spectra of actual and approximated right HRTFs for −20 degrees using the left HRTF of direct sound.

### DETAILED DESCRIPTION

As noted above, properly generating simulated early reflections is important for externalization of virtual sound sources that are rendered for listening via headphones. Early reflections can be generated accurately with respective long FIR filters for left and right channels that have been measured in real rooms, but the computational complexity in terms of memory and number of computations is prohibitive when the simulation is done in real-time with a processor having limited resources, e.g., a personal computer (PC), a mobile phone, a media player, etc. Simplifications can be made to reduce the computational complexity of the simulation method in such processors, but the simplifications must not reduce the quality of the simulation results. Simulating only a few reflections enables buffer memories or tapped delay lines to take the place of long FIR filters, and depending on how many or few taps are used, the computational demands can be very small. Tapped delay lines have been used extensively in the past, but the simplifications performed have mainly been only to account for reflections from walls, floor, and ceiling, which results in very poor externalization.

The inventors have recognized the advantages of considering early reflections from other objects in a room, e.g., desks, chairs, and other furniture, besides the room's walls, floor, and ceiling. Properly simulating early reflections from such objects gives good externalization, but only if each of these reflections provides directional cues. The inventors have also recognized that suitable directional cues can be obtained by HRTF processing, i.e., filtering according to an HRTF, although such filtering is a computationally demanding task.

In accordance with this invention, an HRTF-processed direct-sound signal is used for generating simulated early-reflection signals but is modified in order to approximate the spectral content of the early reflections. This results in enhanced externalization of virtual sound sources. Furthermore, by using cross-coupling in the early-reflection generator, a good approximation of reflections coming from the other side of the listener compared to the direct sound path can be achieved. This also results in a proper intensity balance between left and right channels of the early reflections and enables the same modification parameters to be used independently of the position(s) of the sound source(s). Thus, the modification parameters of the early-reflection generator can be held constant and one early-reflection generator can be used for multiple virtual sound sources.

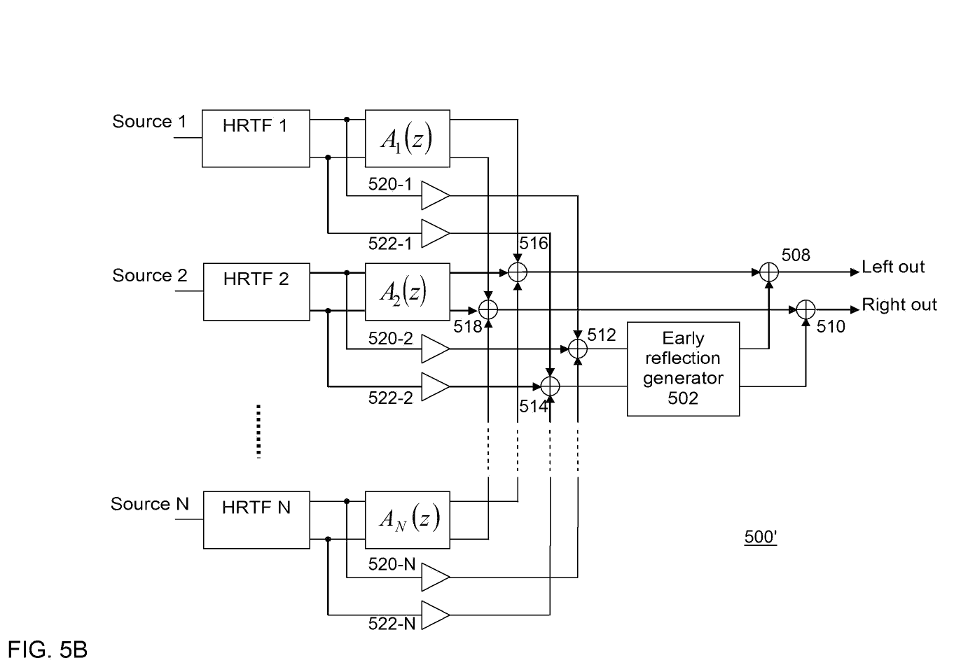

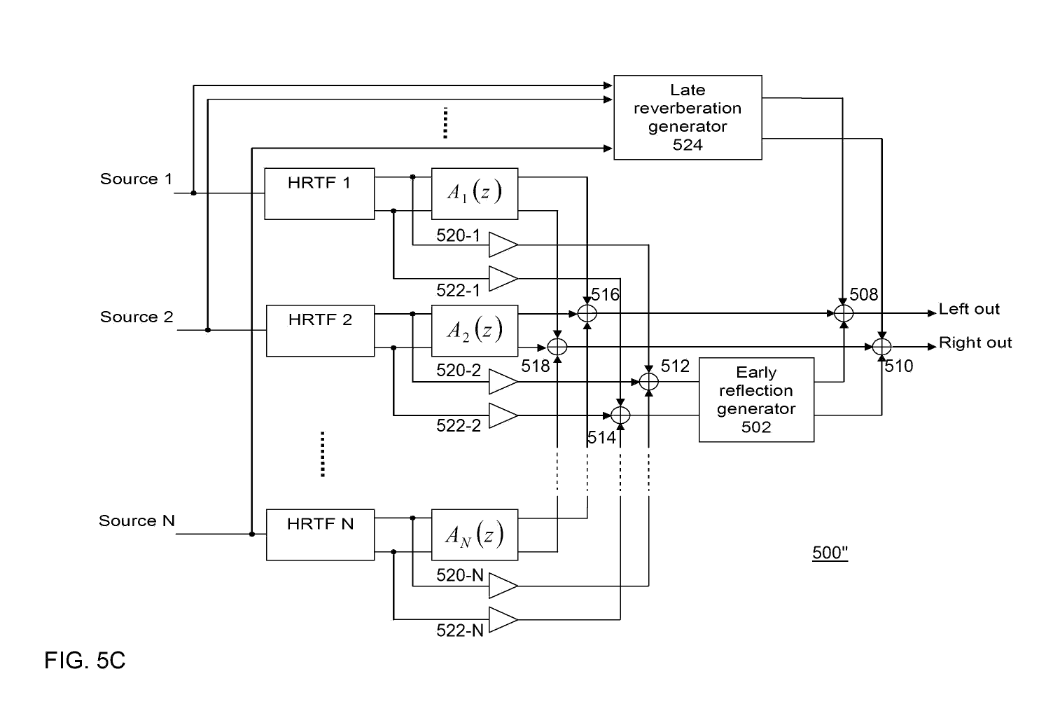

FIG. 5A is a block diagram of a sound-scene simulator 500 that includes HRTF filters H_{l,0}(z), H_{r,0}(z), an early-reflection generator 502, and two attenuation filters A₀(z) 504, 506, one for each of left and right channels. The subscript/indicates the left channel, the subscript r indicates the right channel, and the subscript 0 indicates the direct sound. A monophonic signal from an input source is provided to an input of each of the HRTF filters H_{l,0}(z), H_{r,0}(z), and the outputs of the HRTF filters, which may be called the simulated direct-sound left- and right-channel signals, are provided to the early-reflection generator 502 and the attenuation filters 504, 506. The HRTF for the direct sound depends on only the incidence angle from the sound source to the listener. The outputs of the attenuation filters 504, 506 and the early-reflection generator 502 are combined by respective summers 508, 510 that produce left-channel and right-channel (stereophonic) output signals.

It will be appreciated that the simulator 500 and this application generally focusses on two-channel audio systems simply for convenience of explanation. The left- and right-channels of such systems should be considered more generally as first and second channels of a multi-channel system. The artisan will understand that the methods and apparatus described in this application in terms of two channels can be used for multiple channels.

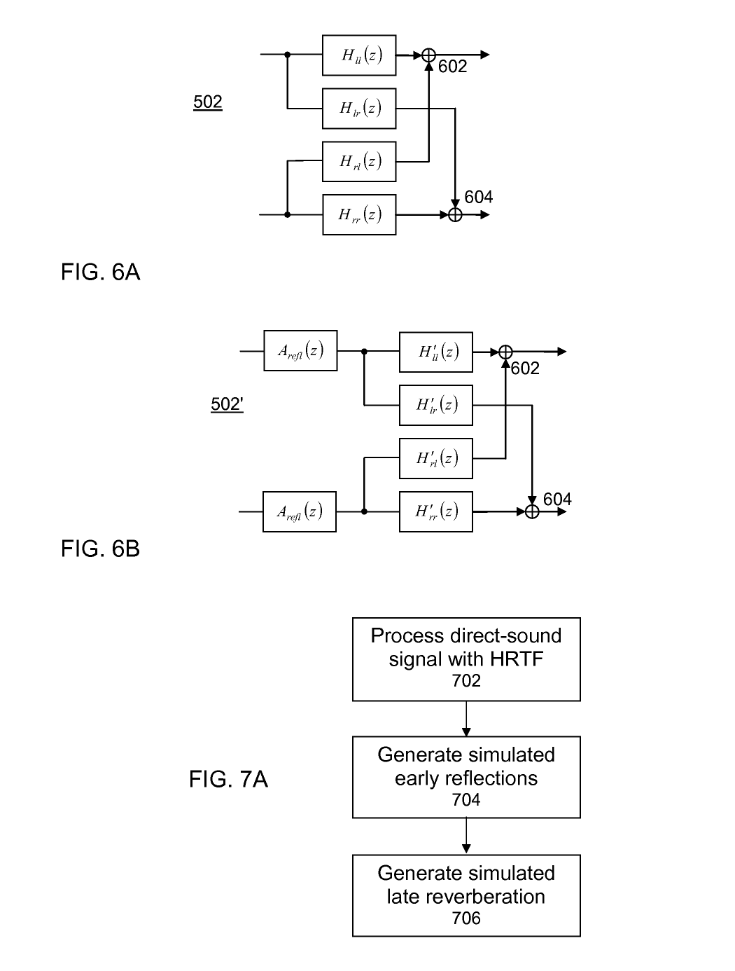

FIG. 6A is a block diagram of a suitable early-reflection generator 502 that includes four adjustment filters, a left-direct filter Hₗₗ(z), a left-cross filter Hₗᵣ(z), a right-cross filter Hᵣᵢ(z), and a right-direct filter Hᵣᵣ(z). The adjustment filters are cross-coupled as shown to modify the simulated direct-sound left- and right-channel signals from the HRTF filters H_{l,0}(z), H_{r,0}(z) (which enter on the left-hand side of the diagram) to simulate spectral content of early reflections. Left- and right-channel signals of the modified simulated direct sound are combined by respective summers 602, 604, and the generated simulated early-reflection signals exit on the right-hand side of the diagram.

As described in more detail below, the left-channel and right-channel output signals Yₗ(z), Yᵣ(z), respectively, of the simulator 500 can be expressed in the frequency (z) domain as follows:

$$\{ \begin{matrix}{Y}_{l} ( z ) = \begin{matrix}{H}_{l , 0} ( z ) X ( z ) ( {A}_{0} ( z ) + {H}_{ll} ( z ) ) + \\ {H}_{r , 0} ( z ) X ( z ) {H}_{rl} ( z )\end{matrix} \\ {Y}_{r} ( z ) = \begin{matrix}{H}_{r , 0} ( z ) X ( z ) ( {A}_{0} ( z ) + {H}_{rr} ( z ) ) + \\ {H}_{l , 0} ( z ) X ( z ) {H}_{lr} ( z )\end{matrix}\end{matrix} \qquad Eq . 1$$

where H_{l,0}(z) is the left HRTF for the direct sound, H_{r,0}(z) is the right HRTF for the direct sound, X(z) is a monophonic input source signal, A₀(z) is the attenuation filter for the direct sound, and Hₗₗ(z), Hₗᵣ(z), Hᵣᵢ(z), Hᵣᵣ(z) are the adjustment filters shown in FIG. 6A. The level change implemented by the attenuation filter A₀(z) is discussed below.

The left-direct, right-direct, left-cross, and right-cross adjustment filters are advantageously set as follows:

$$\{ \begin{matrix}{H}_{ll} ( z ) = {\sum }_{s = 1}^{S} {H}_{llmod , s} ( z ) {z}^{- {m}_{s}} {A}_{s} ( z ) \\ {H}_{rr} ( z ) = {\sum }_{s = 1}^{S} {H}_{rr mod , s} ( z ) {z}^{- {m}_{s}} {A}_{s} ( z ) \\ {H}_{lr} ( z ) = {\sum }_{t = 1}^{T} {H}_{lr mod , t} ( z ) {z}^{- {m}_{t}} {A}_{t} ( z ) \\ {H}_{rl} ( z ) = {\sum }_{t = 1}^{T} {H}_{rl mod , t} ( z ) {z}^{- {m}_{t}} {A}_{t} ( z )\end{matrix} \qquad Eq . 2$$

where H_{ll mod s}(z), H_{rr mod,s}(z), H_{ri mod t}(z), and H_{ri mod t}(z) are modification filters, Aₛ(z) and Aₜ(z) are attenuation filters, S is a number of reflections s that have incidence angles (azimuths) that have the same sign as the incidence angle of the direct sound, and T is a number of reflections t that have incidence angles that have a different sign from the incidence angle of the direct sound. The left-direct modification filter H_{ll mod,s}(z), right-direct modification filter H_{rr mod,s}(z), left-cross modification filter H_{ir mod,t}(z), and right-cross modification filter H_{ri mod,t}(z), the attenuation filters Aₛ(z) and Aₜ(z), and the delays mₛ and mₜ for the respective reflections are determined in manners that are described in more detail below, for example in connection with Eqs. 22, 23.

In an alternative arrangement, the adjustment filters in the early-reflection generator 502 can be implemented by modification filters that use only gains and delays to modify the HRTF-processed direct sound in order to approximate the HRTFs of the reflections. In such an alternative arrangement, the modification filters H_{ll mod,s}(z), H_{rr mod,s}(z), H_{rl mod,t}(z), and H_{ri mod,t}(z) can be set as follows:

$$\{ \begin{matrix} {H}_{ll mod , s} ( z ) \approx {g}_{ll mod , s} {z}^{- Δ {N}_{s}} \\ {H}_{rr mod , s} ( z ) \approx {g}_{rr mod , s} \\ {H}_{lr mod , t} ( z ) \approx {g}_{lr mod , t} {z}^{- Δ {N}_{t}} \\ {H}_{rl mod , t} ( z ) \approx {g}_{rl mod , t}\end{matrix} \qquad Eq . 3$$

where g_{ll mod,s}, g_{rr mod,s}, g_{ir mod,t}, and g_{rl mod,t} are modification gains, ΔNₛ is a delay that adjusts the ITD for the s-th reflection having an incidence angle with a sign that is the same as the sign of the incidence angle of the direct sound, and ΔNₜ is a delay that adjusts the ITD for the t-th reflection having an incidence angle with a sign that is different from the sign of the incidence angle of the direct sound. The modification gains g in Eq. 3 are preferably chosen to conserve the energy of the early reflections as follows (in the discrete-time domain):

$$\{ \begin{matrix}{g}_{ll mod , s} = \sqrt{\frac{energy ( {h}_{l , s} ( n ) )}{energy ( {h}_{l , 0} ( n ) )}} \\ {g}_{rr mod , s} = \sqrt{\frac{energy ( {h}_{r , s} ( n ) )}{energy ( {h}_{r , 0} ( n ) )}} \\ {g}_{lr mod , t} = \sqrt{\frac{energy ( {h}_{r , t} ( n ) )}{energy ( {h}_{l , 0} ( n ) )}} \\ {g}_{rl mod , t} = \sqrt{\frac{energy ( {h}_{l , t} ( n ) )}{energy ( {h}_{r , 0} ( n ) )}}\end{matrix} \qquad Eq . 4$$

where h_{l,0}(n) is the left HRTF for the direct path, h_{r,0}(n) is the right HRTF for the direct path, h_{l,s}(n) is the left HRTF for the s-th reflection, h_{r,s}(n) is the right HRTF for the s-th reflection, h_{l,t}(n) is the left HRTF for the t-th reflection, and h_{r,t}(n) is the right HRTF for the t-th reflection.

The left and right output signals of the simulator 500 given by Eq. 1 can be re-written using the approximations expressed by Eq. 3 as:

$${Y}_{l} ( z ) = {H}_{l , 0} ( z ) X ( z ) ( {A}_{0} ( z ) + {\sum }_{s = 1}^{S} {g}_{ll mod , s} {z}^{- ( {m}_{s} + Δ {N}_{s} )} {A}_{s} ( z ) ) + {H}_{r , 0} ( z ) X ( z ) ( {\sum }_{t = 1}^{T} {g}_{rl mod , t} {z}^{{m}_{t}} {A}_{t} ( z ) ) \\ {Y}_{r} ( z ) = {H}_{r , 0} ( z ) X ( z ) ( {A}_{0} ( z ) + {\sum }_{s = 1}^{S} {g}_{rr mod , s} {z}^{- {m}_{s}} {A}_{s} ( z ) ) + {H}_{l , 0} ( z ) X ( z ) ( {\sum }_{t = 1}^{T} {g}_{lr mod , t} {z}^{- ( {m}_{t} + Δ {N}_{t} )} {A}_{t} ( z ) ) \qquad Eq . 5$$

It will be understood that the only HRTF filtering included in Eqs. 1 and 5 for the simulator 500 is for creating the simulated direct-sound signal.

If it is assumed that all early reflections undergo similar frequency-dependent shaping, the attenuation filters Aₛ(z) and Aₜ(z) can be considered as applying the same spectral shaping but different gains to different reflections. This simplifies Eq. 5 to the following:

$${Y}_{l} ( z ) = {H}_{l , 0} ( z ) X ( z ) ( {A}_{0} ( z ) + {A}_{refl} ( z ) {\sum }_{s = 1}^{S} {g}_{ll mod , s} {z}^{- ( {m}_{s} + Δ {N}_{s} )} {a}_{s} ) + {H}_{r , 0} ( z ) X ( z ) {A}_{refl} ( z ) ( {\sum }_{t = 1}^{T} {g}_{rl mod , t} {z}^{{m}_{t}} {a}_{t} ) \\ {Y}_{r} ( z ) = {H}_{r , 0} ( z ) X ( z ) ( {A}_{0} ( z ) + {A}_{refl} ( z ) {\sum }_{s = 1}^{S} {g}_{rr mod , s} {z}^{- {m}_{s}} {a}_{s} ) + {H}_{l , 0} ( z ) X ( z ) {A}_{refl} ( z ) ( {\sum }_{t = 1}^{T} {g}_{lr mod , t} {z}^{- ( {m}_{t} + Δ {N}_{t} )} {A}_{t} ) \qquad Eq . 6$$

where A_{refl}(z) is a common spectral shaping applied to all early reflections, and aₛ and aₜ are respective gains for the s-th and t-th reflections. The common shaping filter A_{refl}(z) can also be used to adjust the overall intensity, or volume, of the early reflections, which usually decays with respect to distance from the listener in a different way from the volume of the direct sound.

An early-reflection generator 502′ that includes such common spectral shaping filters A_{refl}(z) is depicted in FIG. 6B, and the four adjustment filters H′ₗₗ(z), H′ᵢᵣ(z), H′ᵣₗ(z), H′ᵣᵣ(z) can be set according to the following:

$$\{ \begin{matrix}{H}_{ll}^{′} ( z ) = {\sum }_{s = 1}^{S} {g}_{llmod , s} {z}^{- ( {m}_{s} + Δ {N}_{s} )} {a}_{s} \\ {H}_{rr}^{′} ( z ) = {\sum }_{s = 1}^{S} {g}_{rr mod , s} ( z ) {z}^{- {m}_{s}} {a}_{s} \\ {H}_{lr}^{′} ( z ) = {\sum }_{t = 1}^{T} {g}_{lr mod , t} ( z ) {z}^{- ( {m}_{t} + Δ {N}_{t} )} {a}_{t} \\ {H}_{rl}^{′} ( z ) = {\sum }_{t = 1}^{T} {g}_{rl mod , t} ( z ) {z}^{- {m}_{t}} {a}_{t}\end{matrix} \qquad Eq . 7$$

It can be seen from Eq. 7 that the four adjustment filters now advantageously contain only gains g without spectral shaping, and such filters can be implemented as tapped delay lines with frequency-independent gains (amplifiers) at the output taps.

A suitable arrangement of an early-reflection generator 502″ having an arbitrary number N of cross-coupled channels is depicted in FIG. 6C. In the early-reflection generator 502″, the adjustment filters are denoted as Hᵢⱼ(z), where i is the channel that is cross-coupled and j is the channel the signal is cross-coupled to. As in the generator 502, each channel 1, 2, . . . N has a direct filter, which in the generator 502″ is denoted Hᵢᵢ(z). The adjustment filters are cross-coupled as shown to modify direct-sound N-channel input signals, which enter on the left-hand side of the diagram, to simulate spectral content of early reflections. For 5.1-channel surround sound, N is 5 (or 6 if the bass channel is considered). For headphone use, N would usually be 2, resulting in the arrangement depicted in FIG. 6A, and the input signals would typically come from HRTF filters H_{1,0}(z) and H_{2,0}(z). Channel signals of the modified simulated direct sound are combined by respective summers 602, 604, . . . , 60(2N), and the generated simulated early-reflection signals exit on the right-hand side of the diagram. It will be understood that FIG. 6C shows a number of additional subsidiary summers simply for economy of depiction.

The early-reflection generators 502, 502′, 502″ depicted in FIG. 6 can also be applied to ordinary stereo and other multi-channel signals without HRTF-processing in order to create simulated early reflections. In that case, the direct-sound signal applied to a generator 502, 502′, for example, would be simply the left- and right-channels of the stereo signal.

For today's multi-channel sound systems, such as 5.1-channel and 7.1-channel surround-sound systems, the audio signals provided to the several loudspeakers are usually not HRTF-processed, as in the case of a 3D audio signal intended to be played through headphones. Instead, the virtual azimuth position of a sound source is achieved by stereo panning between two of the loudspeakers. Filtering to simulate a higher or lower elevation may be included in the processing of the surround sound. Although HRTF-processing is not typically involved in surround sound, it should be understood that the early-reflection generators depicted in FIGS. 6A, 6B can be used for surround sound by increasing the number of channels and distributing sounds from one channel to other channels by cross-coupling, as in FIG. 6C. Thus, each surround-sound channel can be cross-coupled to all other channels via adjustment filters, which can also be used for adjusting the elevation of the simulated reflection and the panning of the sound level.

Further simplification of the simulator 500 is possible, e.g., the attenuation filters A₀(z) for the direct sound shown in FIG. 5A can be applied to the monophonic input before the HRTF filters H_{l,0}(z), H_{r,0}(z). The common spectral modification filters A_{refl}(z) in the early generator 502′ shown in FIG. 6B should compensate for that in order to keep the distance attenuation for the early reflections independent of the distance attenuation for the direct sound. If the distance attenuation is implemented as a gain, the compensation is easily implemented through suitable gain adjustments. When other attenuation effects, such as occlusion and obstruction, are implemented in the attenuation filter, the compensation becomes more difficult if these effects are simulated by low-pass filtering.

FIG. 5B depicts a simulator 500′ in which the HRTF-processed direct sound signals of N different sources are individually scaled and then combined by summers 512, 514 before being sent to an early-reflection generator 502 such as those depicted in FIGS. 6A, 6B. The filters A₁(z), A₂(z), . . . , A_{N}(z) are respective attenuation filters for the sources 1, 2, . . . , N that were denoted A₀(z) in FIG. 5A. The outputs of the attenuation filters are combined by summers 516, 518, and their outputs are combined with the outputs of the early reflection generator 502 by summers 508, 510. The input to the early-reflection generator 502 is the sum of amplitude-scaled HRTF processed data, and the gains used for the amplitude scaling, which may be applied by suitable amplifiers 520-1, 522-1; 520-2, 522-2; . . . ; 520-N, 522-N, correspond to the distance gains of the early reflections for each source. It is preferable that the same scaling gains 520, 522 are applied to both channels, although this is not strictly necessary. It should be noted that the gains 520, 522 can also be represented as frequency-dependent filters, and such representation can be useful, for example, when air absorption is simulated as differently affecting different sound sources.

FIG. 5C depicts a simulator 502″ that is similar to the simulator 502′ depicted in FIG. 5B but with a late-reverberation generator 524 that receives the monophonic sound source signal(s) and generates from those input signal(s) left- and right-channel output signals that are sent to the summers 508, 510, which combine them with the respective direct-sound signals from the summers 516, 518, and the early-reverberation signals from the generator 502. The generator 524 can include two FIR filters for simulating the late reverberation, but more preferably it may be a computationally cost-effective late-reverberation generator. The Schroeder and Moorer publications discussed above describe suitable late-reverberation generators, although it is currently believed that those described by Moorer are better alternatives than those described by Schroeder. In addition, such a late-reverberation generator can easily be added to the multi-channel early-reflection generator 502″ depicted in FIG. 6C by using the channel 1, 2, . . . N signals as inputs to the late-reverberation generator.

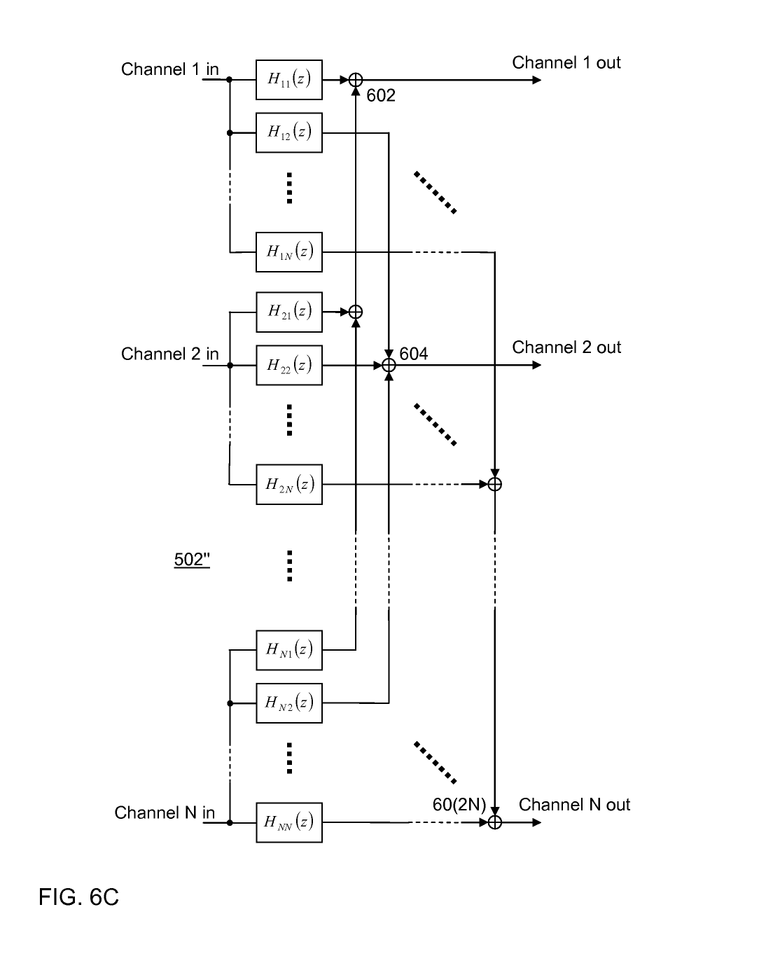

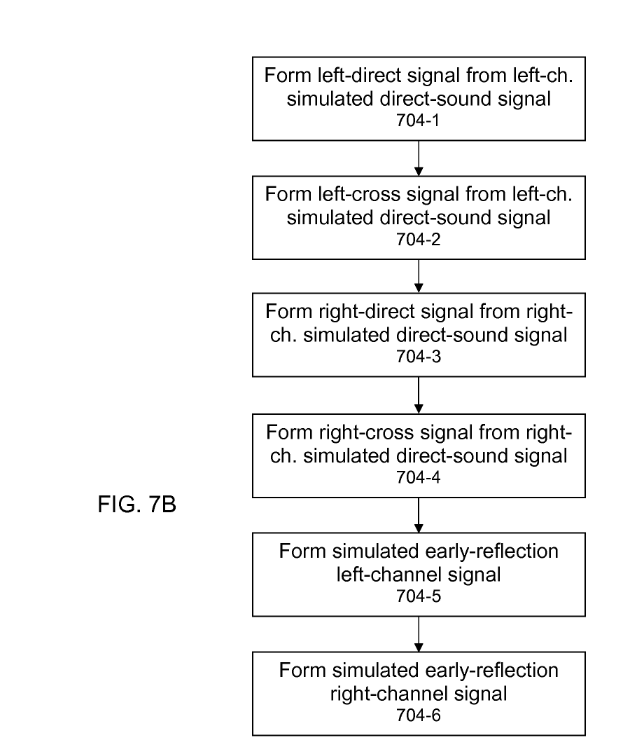

The artisan can now appreciate the flow chart shown in FIG. 7A, which depicts a method of simulating a 3D scene having at least one sound source and at least one sound-reflecting object. The method includes a step 702 of processing a direct-sound signal with at least one HRTF, thereby generating a simulated direct-sound signal. The method also includes a step 704 of generating simulated early-reflection signals from the simulated direct-sound signal, including simulating early reflections having incidence angles different from the incidence angle of the direct sound. The method may also include a step 706 of generating simulated late-reverberation signals from the direct-sound signal.

As described above, generating simulated early-reflection signals may include processing the simulated direct-sound signal with a plurality of adjustment filters, and at least two of the adjustment filters may be cross-coupled. Processing the simulated direct-sound signal may also include conserving the energy of the simulated early reflections. Generating simulated early-reflection signals may include processing the simulated direct-sound signals with at least one spectral modification filter, in which case each of the plurality of adjustment filters may include only a respective gain.

FIG. 7B is a flow chart of a method of generating the simulated early-reflection signals in step 704 by modifying a simulated direct-sound signal to approximate spectral content of early reflections from the at least one sound-reflecting object with cross-coupling between left- and right-channels of the simulated direct-sound signal. The method includes a step 704-1 of filtering the left-channel of the simulated direct-sound signal to form a left-direct signal, a step 704-2 of filtering the left-channel of the simulated direct-sound signal to form a left-cross signal, a step 704-3 of filtering the right-channel of the simulated direct-sound signal to form a right-cross signal, and a step 704-4 of filtering the right-channel of the simulated direct-sound signal to form a right-direct signal. The method further includes a step 704-5 of forming a simulated early-reflection left-channel signal from the left-direct and right-cross signals, and a step 704-6 of forming a simulated early-reflection right-channel signal from the right-direct and left-cross signals. As described above, the filtering steps can be carried out in several ways, including selectively amplifying and delaying the left- and right-channel signals of the simulated direct sound. By these methods, externalization of a simulated sound source is enhanced.

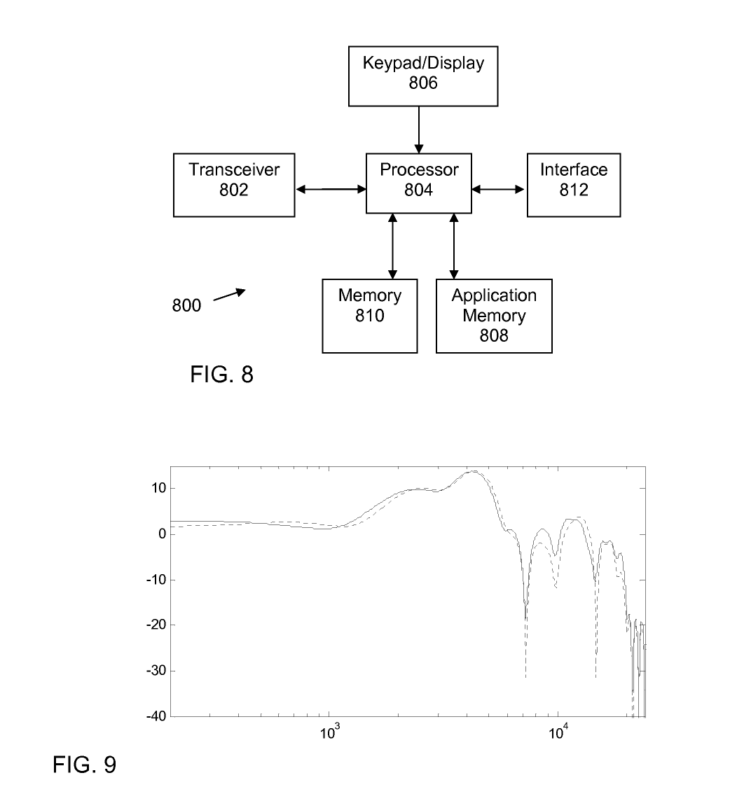

FIG. 8 is a block diagram of a typical user equipment (UE) 800, such as a mobile telephone, which is just one example of many possible devices that can include the devices and implement the methods described in this application. The UE 800 includes a suitable transceiver 802 for exchanging radio signals with a communication system in which the UE is used. Information carried by those radio signals is handled by a processor 804, which may include one or more sub-processors, and which executes one or more software applications and modules to carry out the methods and implement the devices described in this application. User input to the UE 800 is provided through a suitable keypad or other device, and information presented to the user is provided to a suitable display 806. Software applications may be stored in a suitable application memory 808, and the device may also download and/or cache desired information in a suitable memory 810. The UE 800 also includes a suitable interface 812 that can be used to connect other components, such as a computer, keyboard, etc., to the UE 800.

It will be appreciated that the simulation of early reflections is made more efficient by utilizing the externalization in the direct-sound positioning filtering, which must be done anyway. Such externalization subjectively sounds good. The externalization of early reflections is usually more independent of the direction from which the direct sound comes, and the level changes and the mixing left/right take care of this. As seen in FIG. 5B, each 3D source is positioned/externalized, but without applying the level change that is implicit from the positioning. The level change (Aₙ(z)) is then applied for the direct sound separately for each source n. The positioned/externalized signals—without the level change—are mixed into the early reflection effect. By mixing is meant that separately for left/right the level is changed (e.g., by the amplifiers in FIGS. 5B, 5C) for each source and summed per channel. This means that A_{refl}(z) shown in FIG. 6B should not include the source-dependent level change, but only the attenuation that is common for all sources. An alternative is that all sources have their own A_{refl}(z), which means that the respective channel of the sources would be summed in a similar way as above after A_{refl}(z). The early-reflection generator 502′ in FIG. 5B would then contain the right-hand part of FIG. 6B.

When simulating a dynamic 3D audio scene with moving objects and a moving listener, the parameters used by the described early-reverberation generators 502, 502′ must be updated continuously in order to simulate the reflection paths accurately. This is a computationally expensive task since a geometry-based calculation algorithm must be used, e.g., ray tracing, and all parameters of the early-reverberation generator must be changed smoothly in order to avoid unpleasant-sounding artifacts.

The inventors have recognized that it is possible to keep all parameters of the above-described early-reverberation generators static except the attenuation parameter that adjusts the volume with respect to the source-listener distance. Most simulated reflections come from objects other than the walls, floor, and ceiling of a room, and so if such an object, e.g., a chair or a table, moves a little, the simulated early reflections change. Nevertheless, humans do not notice such small movements. Therefore, adjustments of the different parameters of the early-reflection generator done for one particular position of a sound source can also result in good externalization for all other source positions. Since the adjustments are applied on the HRTF-filtered direct sound, the simulated early reflections change with respect to the position of the sound source, which is also the case for real early reflections. And since the adjustments are relative to the direct sound, the result is always that reflections coming from angles around the angle of the direct sound path are simulated.

An advantage of the cross-coupling in the early-reflection generators shown in FIGS. 6A, 6B when the parameters are kept static is that the intensities of the left and right channels of the early reverberation are kept more balanced for all positions of a sound source than is the case for the direct sound. For example, the difference between the intensities of the left and right HRTFs for angles to the sides of the listener can be large, but for the early reverberation, the intensity difference should not be large. This is achieved by the cross-coupling. When using static filters without cross-coupling, on the other hand, the intensity difference would change linearly with the intensity difference between the left and right channel of the direct sound, which neither reflects reality nor sounds good.

The good performance when using static parameters in the early-reverberation generator irrespective of the position of a sound source also makes it possible to use the same generator for all sound sources in an auditory scene, which reduces the computational complexity compared to the case in which each sound source is processed in its own respective early-reflection generator. Despite using the same adjustment parameters for all sources, the simulated early reflections will be different for sources at different positions since the HRTF-processed input signals (the simulated direct sounds) will be different.

The following is a further technical explanation and mathematical development of the simulators and generators described above.

As noted above, the times of arrival and the incidence angles of reflections can be calculated using for example ray tracing or an image source method. Advantages of using these methods are that one can design different rooms with different characteristics and that the early reflections can be updated when simulating a dynamic scene with moving objects. Another way of obtaining early reflections is to make an impulse response measurement of a room. This would enable accurate simulation of early reverberation, but impulse response measurements are difficult to perform and correspond only to a static scene.

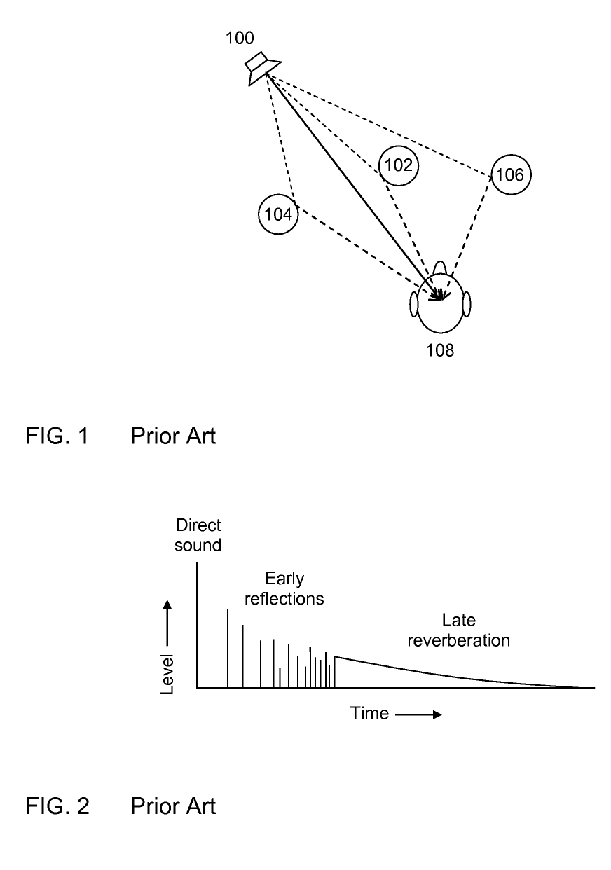

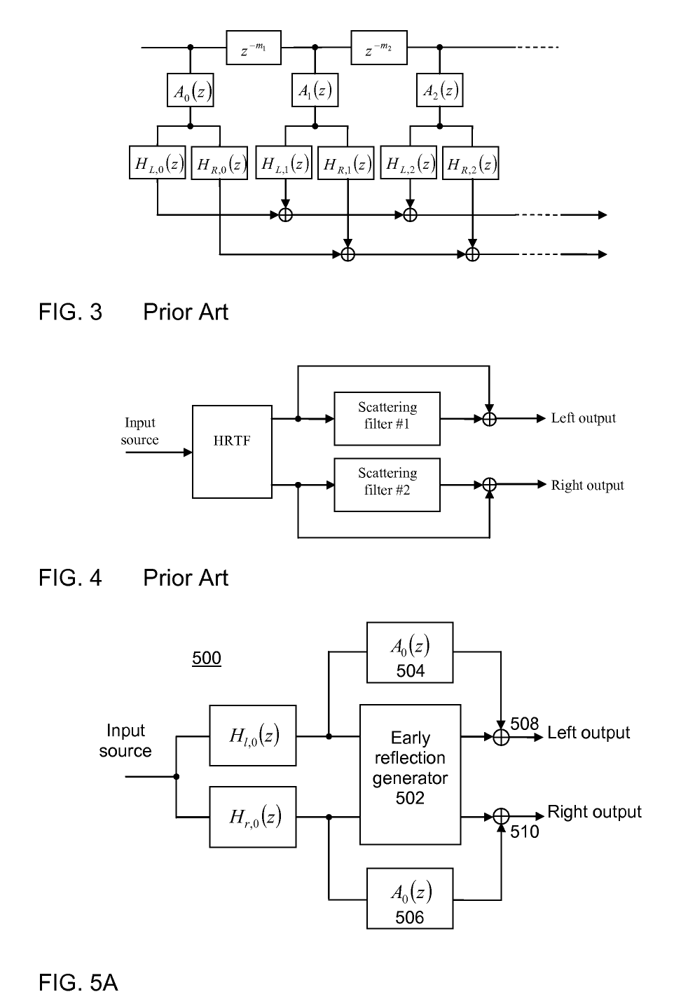

Referring again to FIG. 1, in which a listener is reached by the direct sound from a sound source 100 and reflections from three objects 102, 104, 106, the sounds reaching the left and right ears of the listener, yₗ(n) and yᵣ(n), respectively, are given by:

$$\{ \begin{matrix}{y}_{l} ( n ) = {h}_{l , 0} ( n ) * x ( n ) * {a}_{0} ( n ) + {\sum }_{k = 1}^{3} {h}_{l , k} ( n ) * x ( n - {m}_{k} ) * {a}_{k} ( n ) \\ {y}_{r} ( n ) = {h}_{r , 0} ( n ) * x ( n ) * {a}_{0} ( n ) + {\sum }_{k = 1}^{3} {h}_{r , k} ( n ) * x ( n - {m}_{k} ) * {a}_{k} ( n )\end{matrix} \qquad Eq . 8$$

where x(n) is a monophonic input signal, h_{l,k}(n) is the left HRTF for the k-th reflection, h_{r,k}(n) is the right HRTF for the k-th reflection, aₖ(n) is the attenuation filter for the k-th reflection and mₖ is the delay of the k-th reflection with respect to the direct sound (not the additional delay shown in FIG. 3). Subscript 0 means the direct sound and * means convolution. In the frequency domain, Eq. 8 is given by:

$$\{ \begin{matrix}{Y}_{l} ( z ) = {H}_{l , 0} ( z ) X ( z ) {A}_{0} ( z ) + {\sum }_{k = 1}^{3} {H}_{l , k} ( z ) X ( z ) {z}^{- {m}_{k}} {A}_{k} ( z ) \\ {Y}_{r} ( z ) = {H}_{r , 0} ( z ) X ( z ) {A}_{0} ( z ) + {\sum }_{k = 1}^{3} {H}_{r , k} ( z ) X ( z ) {z}^{- {m}_{k}} {A}_{k} ( z )\end{matrix} \qquad Eq . 9$$

It will be noted that the delay of the direct sound from the sound source to the listener is omitted from Eqs. 8 and 9 for simplicity, but that delay can be taken into account by adding an additional delay to x(n) and all x(n−mₖ). The attenuation filter for the direct sound, a₀(n), simulates the distance attenuation and can be implemented as a low-pass filter or more commonly as a frequency-independent gain. It is also possible to include the effects of obstruction and occlusion in the attenuation filter, and both effects usually cause the sound to be low-pass filtered. The attenuation filters for the reflections, aₖ(n), simulate the same effects as the attenuation filter for the direct sound, but here also the attenuation of the sound that occurs during reflection may be considered. Most materials absorb high-frequency energy more than low-frequency energy, which results in an effective low-pass filtering of the reflected sound.

In an arrangement like that depicted in FIG. 1, no sound path is obstructed or occluded, and if the lengths of the sound paths are short, the distance attenuation can be simulated by frequency-independent gains. Sound intensity generally follows an inverse-square law, meaning that for each doubling of distance, the intensity drops by 6 dB, but Eqs. 8 and 9 are written in terms of sound amplitude, which follows an inverse law given by the following:

$${a}_{new} = {a}_{reference} \cdot ( \frac{{d}_{reference}}{{d}_{new}} ) \qquad Eq . 10$$

where a_{reference} is the reference gain at distance d_{reference} and a_{new} is the amplitude attenuation to be calculated at the distance d_{new} from the sound source. Thus, in order to calculate the gain for a given distance, a reference gain for a reference distance is needed.

For example, assume a reference gain of 0.5 for a distance of 0.5 m from the source 100 in FIG. 1, and let the distance traveled by the sound from the source 100 to the listener 108 be 2.00 m for the direct sound, 2.06 m for the reflection from object 102, 2.17 m for the reflection from object 104, and 2.67 m for the reflection from object 106. For this example, the respective distance-attenuation gains can be calculated as 0.125, 0.121, 0.115, and 0.094, and thus, the attenuation filter for the direct sound, A₀(z), is frequency-independent and equals 0.125. The attenuation filters for the reflections, however, should also take into account the filtering that occurs during the reflection.

Different objects usually affect sound differently, but for simplicity, let the three reflecting objects 102,104,106 in this example affect the sound equally and let the reflection be simulated by a low-pass infinite impulse response (IIR) filter described by the following:

$$H ( z ) = \frac{0.28 + 0.28 \cdot {z}^{- 1}}{1.0 - 0.38 \cdot {z}^{- 1}} \qquad Eq . 11$$

The attenuation filter for the k-th reflection, Aₖ(z), should include both this reflection filter and the respective distance-attenuation gain calculated above, which can be accomplished by multiplying the numerator of H(z) by the respective distance-attenuation gain.

Assuming the speed of sound is 340 m/s and the sampling frequency is 48 kHz, the delays mₖ of the reflections with respect to the direct sound can also be computed according to the following:

mₖ=(dₖ−d₀)·48000/340 Eq. 12

where d₀ is the distance for the direct sound, and dₖ is the distance for the k-th reflection. For this example, the delay is m₁=8.5 samples for the reflection from object 102, m₂=24.0 samples for the reflection from object 104, and m₃=94.6 samples for the reflection from object 106. It can be seen that the delays are not integer numbers of samples taken at 48 kHz, and so interpolation can be used to compute the delays. Interpolation is not necessary, however, as the delays can be rounded to integers. Rounding reduces the accuracy of the simulation in comparison to interpolation, but integer resolution is in many cases accurate enough.

As can be seen from Eqs. 8 and 9, apart from the HRTF filtering needed to create the simulated direct-sound signal, it is also necessary to perform HRTF filtering for each reflection. If the ITD is extracted from the HRTFs, a common length of those filters is 1 ms, which means 48 samples at a sampling rate 48 kHz. Filtering an input sequence with a FIR filter of length 48 samples usually requires about 2 mega-operations per second (MOPS), which means that for each reflection, 4 MOPS is needed for creating a stereo output sequence. In this example of three reflections, 12 MOPS is needed for the HRTF filtering, but for a convincing externalization effect, simulating only three reflections is not enough. Thus, the additional computational load will be much more than 12 MOPS for a properly simulated early reverberation. In the following description, it is assumed that there exist K reflections.

Reducing the lengths of the HRTFs is a first obvious simplification that has been used in prior simulators to decrease the number of computations required, but this also severely degrades the quality of the simulated early reverberation because the directional cues are decreased or even removed. Therefore, this is not further considered here.

A second, better simplification is to assume that most reflections come from angles similar to the angle of the direct sound. In that case, the directional cues obtained when using the HRTFs for the direct sound can be reused and modified so that they approximate the directional cues of each reflection.

Assume that the directional cues of the HRTFs used for the direct sound can be changed by filtering those HRTFs with the modification filters h_{l mod,k}(n) and h_{r mod,k}(n) such that:

$$\{ \begin{matrix}{h}_{l , k} ( n ) = {h}_{l , 0} ( n ) * {h}_{l mod , k} ( n ) \\ {h}_{r , k} ( n ) = {h}_{r , 0} ( n ) * {h}_{r mod , k} ( n )\end{matrix} \qquad Eq . 13$$

or equivalently in the frequency domain:

$$\{ \begin{matrix}{H}_{l , k} ( z ) = {H}_{l , 0} ( z ) {H}_{l mod , k} ( z ) \\ {H}_{r , k} ( z ) = {H}_{r , 0} ( z ) {H}_{r mod , k} ( z )\end{matrix} \qquad Eq . 14$$

Inserting Eq. 14 in Eq. 9 and assuming K reflections yields the following:

$$\{ \begin{matrix}{Y}_{l} ( z ) = {H}_{l , 0} ( z ) X ( z ) ( {A}_{0} ( z ) + {\sum }_{k = 1}^{K} {H}_{l mod , k} ( z ) {z}^{- {m}_{k}} {A}_{k} ( z ) ) \\ {Y}_{r} ( z ) = {H}_{r , 0} ( z ) X ( z ) ( {A}_{0} ( z ) + {\sum }_{k = 1}^{K} {H}_{r mod , k} ( z ) {z}^{- {m}_{k}} {A}_{k} ( z ) )\end{matrix} \qquad Eq . 15$$

or equivalently in the discrete-time domain:

$$\{ \begin{matrix}{y}_{l} ( n ) = {h}_{l , 0} ( n ) * ( x ( n ) * {a}_{0} ( n ) + {\sum }_{k = 1}^{K} {h}_{l mod , k} ( n ) * x ( n - {m}_{k} ) * {a}_{k} ( n ) ) \\ {y}_{r} ( n ) = {h}_{r , 0} ( n ) * ( x ( n ) * {a}_{0} ( n ) + {\sum }_{k = 1}^{K} {h}_{r mod , k} ( n ) * x ( n - {m}_{k} ) * {a}_{k} ( n ) )\end{matrix} \qquad Eq . 16$$

It can be seen from Eqs. 15 and 16 that the HRTF filtering of the reflections has been removed, but finding a solution to Eq. 13 involves deconvolution, which is known to be a difficult task in signal processing today. If an exact and stable solution exists, the modification filters h_{l mod,k}(n) and h_{r mod,k}(n) will most probably need to be realized as very long FIR filters or complex IIR filters. From a computational complexity point of view, therefore, nothing has been gained by the second simplification.

If an exact solution to Eq. 13 is not required, then the modification filters h_{l mod,k}(n) and h_{r mod,k}(n) can be realized as short, low-complexity, FIR filters, or even as constants and delays. Using a single constant and a single delay for each reflection means that the entire spectral content of the direct sound's HRTFs are reused, and only the IID and the ITD are modified. As one example, such single modification constants g can be chosen such that the energy change that would have been imposed by the actual HRTFs of the reflection is conserved when the HRTFs of the direct sound are used as follows:

$$\{ \begin{matrix}{g}_{l mod , k} = \sqrt{\frac{energy ( {h}_{l , k} ( n ) )}{energy ( {h}_{l , 0} ( n ) )}} \\ {g}_{r mod , k} = \sqrt{\frac{energy ( {h}_{r , k} ( n ) )}{energy ( {h}_{r , 0} ( n ) )}}\end{matrix} \qquad Eq . 17$$

The ITD of the HRTFs can be fractional, but for simplicity it can be assumed that they are integer values. Assuming that the ITD of the direct sound is N₀ samples and the ITD of the k-th reflection is Nₖ samples, then the adjustment of the ITD for the k-th reflection should be set as:

ΔNₖ=Nₖ−N₀ Eq. 18

Adjusting the ITD can be accomplished by changing the delay of both the channels, e.g., adjusting half of it on the left channel and the other half on the right channel, but the delay adjustment can instead be applied to only one of the channels, i.e., the left channel. This results in that the modification filters can be approximated as:

$$\{ \begin{matrix} {H}_{l mod , k} ( z ) \approx {g}_{l mod , k} {z}^{- Δ {N}_{k}} \\ {H}_{r mod , k} ( z ) \approx {g}_{r mod , k}\end{matrix} \qquad Eq . 19$$

Inserting Eq. 19 in Eq. 15 gives:

$$\{ \begin{matrix} {Y}_{l} ( z ) \approx {H}_{l , 0} ( z ) X ( z ) ( {A}_{0} ( z ) + {\sum }_{k = 1}^{K} {g}_{l mod , k} {z}^{- ( {m}_{k} + Δ {N}_{k} )} {A}_{k} ( z ) ) \\ {Y}_{r} ( z ) \approx {H}_{r , 0} ( z ) X ( z ) ( {A}_{0} ( z ) + {\sum }_{k = 1}^{K} {g}_{r mod , k} {z}^{- {m}_{k}} {A}_{k} ( z ) )\end{matrix} \qquad Eq . 20$$

or equivalently in the discrete-time domain:

$$\{ \begin{matrix} {y}_{l} ( n ) \approx {h}_{l , 0} ( n ) * ( \begin{matrix}x ( n ) * {a}_{0} ( n ) + {\sum }_{k = 1}^{K} {g}_{l mod , k} * \\ x ( n - {m}_{k} - Δ {N}_{k} ) * {a}_{k} ( n )\end{matrix} ) \\ {y}_{r} ( n ) \approx {h}_{r , 0} ( n ) * ( x ( n ) * {a}_{0} ( n ) + {\sum }_{k = 1}^{K} {g}_{r mod , k} * x ( n - {m}_{k} ) * {a}_{k} ( n ) )\end{matrix} \qquad Eq . 21$$

As can be seen, the HRTF filtering of the reflections has been removed and only a multiplication by a gain parameter (in general, an amplifier) is needed for each reflection. If in FIG. 1 it is assumed that the sound source 100 and the reflective objects 102,104, 106 lie in the same plane as the listener's ears, i.e., the elevation angle is 0, then all sound paths reach the listener in the horizontal plane from different angles (azimuths), which can be said arbitrarily to have positive signs if they are to the left of a normal to the listener and negative signs if they are to the right of the normal to the listener. Azimuth 0 is straight ahead from (normal to) the listener. Applying this convention to the arrangement depicted in FIG. 1, the incidence angle of the direct sound is 35°, the reflection from object 102 is 25°, and the reflection from object 106 is −20°. Assuming a sampling frequency of 48 kHz and the energy of the left HRTF for the angle 35° is 3.316, the energy of the right HRTF is 0.366 and the ITD is −13 samples. The corresponding energy values of the left and right HRTFs for the angle 25° are 2.695 and 0.570, respectively, and the ITD is −9 samples, and the corresponding energy values of the left and right HRTFs for the angle −20° are 0.688 and 2.355, respectively, with an ITD of 8 samples. Applying further simplifications that the HRTFs from the direct sound can be reused and that only the amplitude and ITD are modified, the spectra shown in FIGS. 9-14 are obtained.

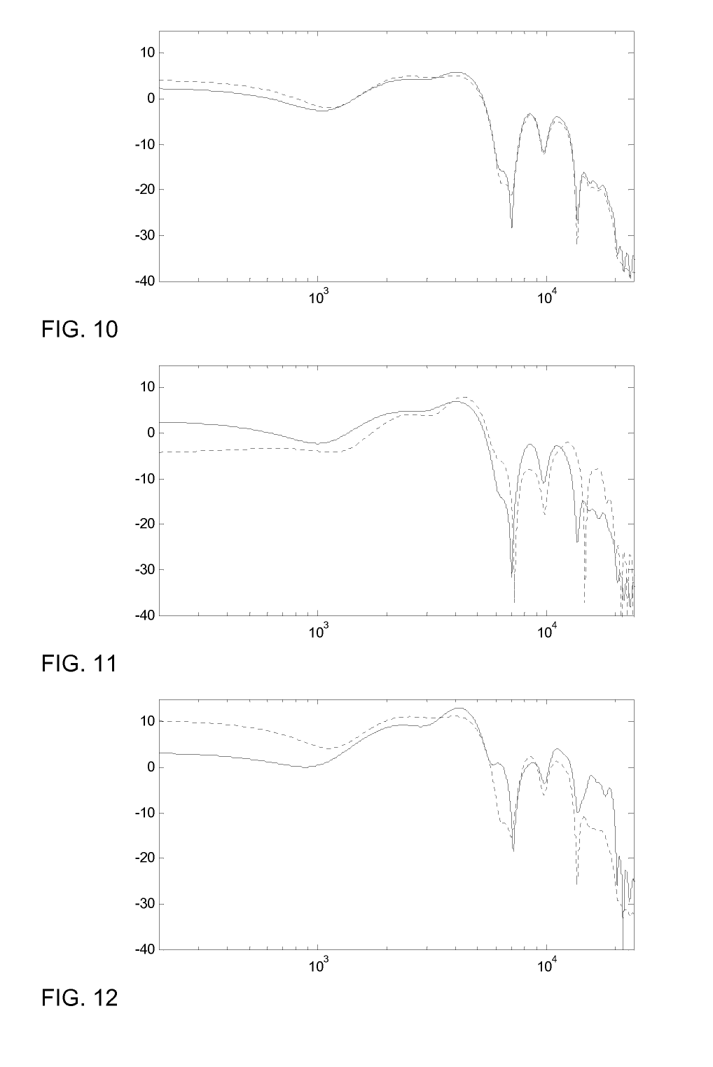

FIG. 9 shows the spectra of the left HRTFs for an angle of arrival of 25°, with the actual HRTF indicated by the solid line and the approximated HRTF indicated by the dashed line, and FIG. 10 shows the spectra of the right HRTFs for 25°, with the actual HRTF indicated by the solid line and the approximated HRTF indicated by the dashed line. The approximated HRTFs were obtained by scaling the HRTFs of the direct sound with the modification filters given by Eq. 19. The gain g_{l mod,k} was set according to Eq. 17 to 0.9015 (i.e., the square root of 2.695/3.316), the gain g_{r mod,k} was set to 1.2479 (i.e., the square root of 0.570/0.366), and ΔNₖ was set according to Eq. 18 to 4 (i.e., (−9)-(−13)). In both figures, the x-axis shows the frequency and the y-axis shows the intensity in decibels (dB). From FIGS. 9 and 10, it can be seen that the deviations between the actual HRTFs and the approximated ones appear to be small, but even such small deviations arise from incidence angles that differ by only 100.

FIGS. 11 and 12 illustrate the deviations when the incidence angles differ by 55°, which is the difference between the incidence angle of the direct sound and the incidence angle (−20°) of reflections from object 106 in FIG. 1. FIG. 11 shows the spectra of the left HRTFs for −20°, with the actual HRTF indicated by the solid line and the approximated HRTF indicated by the dashed line, and FIG. 12 shows the spectra of the right HRTFs for −20°, with the actual HRTF indicated by the solid line and the approximated HRTF indicated by the dashed line. As in the previous example, the approximated HRTFs were obtained by scaling the HRTFs of the direct sound with the modification filters given by Eq. 19. The gain g_{l mod,k} was set according to Eq. 17 to 0.4555 (i.e., the square root of 0.688/3.316), the gain g_{r mod,k} was set to 2.5366 (i.e., the square root of 2.355/0.366), and ΔNₖ was set according to Eq. 18 to 21 (i.e., 8-(−13)). In both figures, the x-axis shows the frequency and the y-axis shows the intensity in dB.

From FIG. 11, it can be seen that the approximation of the left HRTF has too little low-frequency energy and too much high-frequency energy. For the approximated right HRTF, the situation is the opposite: too much low-frequency energy and too little high-frequency energy, which can be seen from FIG. 12. Thus, for an angle of arrival of −20°, the approximation would produce simulated reflections that sound annoying, especially because of the boost of the low frequencies caused by the approximated right HRTF.

One way of avoiding this is to restrict the modification gains when approximating a reflection that comes from the other side of the listener compared to the direct sound path, i.e., when the sign of the azimuth angle of the reflection differs from the sign of the azimuth angle of the direct sound. Restricting the gain for the right HRTF to a lower value than the one used in the example depicted in FIG. 12 reduces the low frequency artifacts, but the approximation is still not good as the spectra does not match the actual HRTFs well and the restriction results in an erroneous IID.

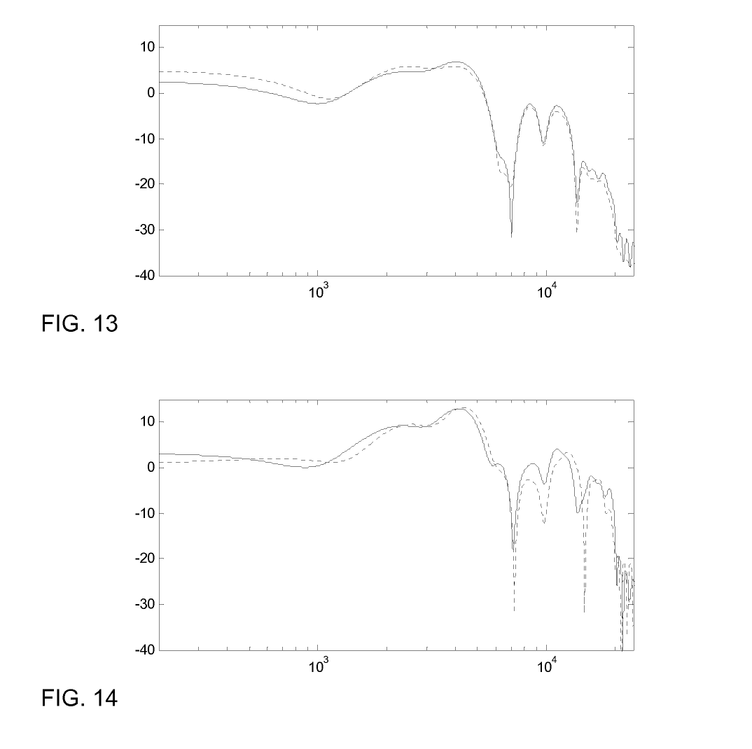

Because a person's head and body are more or less symmetrical, the HRTFs of a reflection coming from the person's right would be better approximated from the HRTFs of a direct sound coming from the person's left if the filters are switched, i.e., the left HRTF of the reflection is approximated based on the right HRTF of the direct sound and the right HRTF of the reflection is approximated based on the left HRTF of the direct sound. FIGS. 13 and 14 illustrate this technique applied to reflections from object 106 in FIG. 1. As in the previous examples, the energies of the filtered signals are preserved and the ITD has been changed.

FIG. 13 shows the spectra of the left HRTFs for −20°, with the actual HRTF indicated by the solid line and the approximated HRTF indicated by the dashed line when the right HRTF of the direct sound has been used, and FIG. 14 shows the spectra of the right HRTFs for −20°, with the actual HRTF indicated by the solid line and the approximated HRTF indicated by the dashed line when the left HRTF of the direct sound has been used. The approximated left HRTF was obtained by scaling the right HRTF of the direct sound with a gain of 1.3711 (i.e., the square root of 0.688/0.366), the approximated right HRTF was obtained by scaling the left HRTF of the direct sound with a gain of 0.8427 (i.e., the square root of 2.355/3.316), the ITD would be adjusted by −5 samples (i.e., 8-13). In both figures, the x-axis shows the frequency and the y-axis shows the intensity in dB.

Comparing FIGS. 11 and 12 with FIGS. 13 and 14, it can be seen that the latter approximation is much more accurate than the former. Hence, for reflections coming from the same side of the listener as the direct sound, the left HRTF of the direct sound should be used for the left HRTF of the reflection and the right HRTF of the direct sound should be used for the right HRTF of the reflection. For reflections coming from a side of the listener that is opposite to the direct sound, the left and right HRTFs should be switched when approximating the HRTFs of the reflection.

This changes the definitions of the modification filters. If the signs of the azimuths of the direct sound and the reflection are the same, then the modification filters h_{ll mod,k}(n) and h_{rr mod,k}(n) should be chosen such that the following is fulfilled:

$$\{ \begin{matrix}{h}_{l , k} ( n ) = {h}_{l , 0} ( n ) * {h}_{ll mod , k} ( n ) \\ {h}_{r , k} ( n ) = {h}_{r , 0} ( n ) * {h}_{rr mod , k} ( n )\end{matrix} \qquad Eq . 22$$

If the signs are different, i.e., the reflection comes from the opposite side of the listener compared to the direct sound, then the modification filters h_{ir mod, k}(n) and h_{ri mod,k}(n) should be chosen such that the following is fulfilled:

$$\{ \begin{matrix}{h}_{l , k} ( n ) = {h}_{r , 0} ( n ) * {h}_{rl mod , k} ( n ) \\ {h}_{r , k} ( n ) = {h}_{l , 0} ( n ) * {h}_{lr mod , k} ( n )\end{matrix} \qquad Eq . 23$$

The left and right output signals are then given by:

$$\{ \begin{matrix}\begin{matrix}{y}_{l} ( n ) = {h}_{l , 0} ( n ) * ( x ( n ) * {a}_{0} ( n ) + {\sum }_{s = 1}^{S} {h}_{ll mod , s} ( n ) * \\ x ( n - {m}_{s} ) * {a}_{s} ( n ) ) + {h}_{r , 0} ( n ) * \\ ( {\sum }_{t = 1}^{T} {h}_{rl mod , t} ( n ) * x ( n - {m}_{t} ) * {a}_{t} ( n ) )\end{matrix} \\ \begin{matrix}{y}_{r} ( n ) = {h}_{r , 0} ( n ) * ( x ( n ) * {a}_{0} ( n ) + {\sum }_{s = 1}^{S} {h}_{rr mod , s} ( n ) * \\ x ( n - {m}_{s} ) * {a}_{s} ( n ) ) + {h}_{l , 0} ( n ) * \\ ( {\sum }_{t = 1}^{T} {h}_{lr mod , t} ( n ) * x ( n - {m}_{t} ) * {a}_{t} ( n ) )\end{matrix}\end{matrix} \qquad Eq . 24$$

where S is a number of reflections s that have incidence angles with signs that are the same as the sign of the incidence angle of the direct sound, and T is a number of reflections t that have incidence angles with signs that are different from the sign of the incidence angle of the direct sound. Eq. 24 can be given in the equivalent frequency domain as Eq. 1.

Systems and methods implementing these expressions are shown in FIGS. 5-7 described above.

The above-described systems and methods for simulating 3D sound scenes and early reverberations provide early reverberation that sounds good with good externalization at low computational cost. In comparison to prior efforts, the above-described systems and methods enjoy the benefits of reusing the spectral content of the simulated direct sound, which removes the computationally costly HRTF filtering needed for each early reflection. In addition, cross-coupling in the early-reflection generator provides good approximations of reflections coming from a side of a listener opposite to that of the direct sound, and also results in a balanced intensity difference between left and right channels of the early reverberation. The modification parameters of the early reflection generator can be kept constant, which means that no update is needed when the sound source(s) and/or the listener move and that the same generator can be used for an arbitrary number of sound sources without increasing the computational cost. The early-reflection generator is scalable in the sense that the computations and memory required can be adjusted by changing the number of reflections that are simulated, and the early-reflection generator can be applied to audio data that already has been 3D audio rendered in order to enhance the externalization of such data.

It is expected that this invention can be implemented in a wide variety of environments, including for example mobile communication devices. It will be appreciated that procedures described above are carried out repetitively as necessary. To facilitate understanding, many aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both. Many communication devices can easily carry out the computations and determinations described here with their programmable processors and associated memories and application-specific integrated circuits.

Moreover, the invention described here can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of generating signals that simulate early reflections of sound from at least one simulated sound-reflecting object, comprising the steps of:
filtering a simulated direct-sound first-channel signal to form a first-direct filtered signal;
filtering the simulated direct-sound first-channel signal to form a first-cross filtered signal;
filtering a simulated direct-sound second-channel signal to form a second-cross filtered signal;
filtering the simulated direct-sound second-channel signal to form a second-direct filtered signal;
forming a simulated early-reflection first-channel signal from the first-direct and second-cross filtered signals; and
forming a simulated early-reflection second-channel signal from the second-direct and first-cross filtered signals.

2. The method of claim 1, wherein each filtering step comprises steps of filtering the respective simulated direct-sound signal based on each simulated sound-reflecting object, and combining respective simulated direct-sound signals filtered according to simulated sound-reflecting objects to form the respective filtered signal.

3. The method of claim 2, wherein at least one of the steps of filtering the respective simulated direct-sound signal based on each simulated sound-reflecting object comprises selectively amplifying and delaying the respective simulated direct-sound signal.

4. The method of claim 3, wherein selectively amplifying the respective simulated direct-sound signal comprises conserving an energy of the respective simulated early-reflection signal.

5. The method of claim 3, wherein at least one of the steps of filtering the respective simulated direct-sound signal based on each simulated sound-reflecting object further comprises applying a spectral shape that is common to the simulated sound-reflecting objects.

7. The method of claim 1, further comprising the step of filtering a direct-sound signal according to first and second head-related transfer-functions, thereby forming the simulated direct-sound first- and second-channel signals.

8. The method of claim 7, further comprising the steps of:
filtering the simulated direct-sound first- and second-channel signals with respective attenuation filters;
combining the simulated early-reflection first-channel signal with a filtered simulated direct-sound first-channel signal to form a first-channel output signal; and
combining the simulated early-reflection second-channel signal with a filtered simulated direct-sound second-channel signal to form a second-channel output signal.

9. The method of claim 8, further comprising the steps of:
generating simulated late-reverberation first- and second-channel signals from the direct-sound signal;
combining the simulated late-reverberation first-channel signal with the first-channel output signal; and
combining the simulated late-reverberation second-channel signal with the second-channel output signal.

10. A generator configured to produce, from at least first- and second-channel signals, simulated early-reflection signals from a plurality of simulated sound-reflecting objects, comprising:
a first direct filter configured to form a first-direct filtered signal based on the first-channel signal;
a first cross filter configured to form a first-cross filtered signal based on the first-channel signal;
a second cross filter configured to form a second-cross filtered signal based on the second-channel signal;
a second direct filter configured to form a second-direct filtered signal based on the second-channel signal;
a first combiner configured to form a simulated early-reflection first-channel signal from the first-direct and second-cross filtered signals; and
a second combiner configured to form a simulated early-reflection second-channel signal from the second-direct and first-cross filtered signals.

11. The generator of claim 10, wherein each filter is configured to filter the respective channel signal based on each simulated sound-reflecting object, and to combine the respective channel signal filtered according to the simulated sound-reflecting objects to form the respective filtered signal.

12. The generator of claim 11, wherein at least one of the filters comprises an amplifier having a selectable gain and a delay element having a selectable delay, the amplifier and delay element being configured selectively to amplify and delay the respective channel signal.

13. The generator of claim 12, wherein the respective channel signal is selectively amplified such that an energy of the respective simulated early-reflection signal is conserved.

14. The generator of claim 12, wherein at least one of the filters further comprises a shaping filter that applies a spectral shape that is common to the simulated sound-reflecting objects.

15. The generator of claim 10, further comprising a first head-related transfer-function (HRTF) filter configured to form the first channel signal from a direct-sound signal based on a first HRTF, and a second HRTF filter configured to form the second channel signal from the direct-sound signal based on a second HRTF.

16. The generator of claim 15, further comprising:
a first attenuation filter configured to receive the first-channel signal and produce a first filtered signal;
a second attenuation filter configured to receive the second-channel signal and produce a second filtered signal;
a third combiner configured to form a first channel output signal from the first filtered signal and the simulated early-reflection first-channel signal; and
a fourth combiner configured to form a second channel output signal from the second filtered signal and the simulated early-reflection second-channel signal.

17. The generator of claim 16, further comprising:
a late-reverberation generator configured to form simulated late-reverberation first- and second-channel signals from the direct-sound signal;
a fifth combiner configured to combine the simulated late-reverberation first-channel signal with the first channel output signal; and
a sixth combiner configured to combine the simulated late-reverberation second-channel signal with the second-channel output signal.

18. The generator of claim 10, further comprising:
a late-reverberation generator configured to form at least first- and second-channel simulated late-reverberation signals from the at least first- and second-channel signals; and
a fifth combiner configured to combine the simulated late-reverberation signals with the simulated early-reflection signals.

19. A computer-readable medium having stored instructions that, when executed by a computer, cause the computer to generate signals that simulate early reflections of sound from at least one simulated sound-reflecting object by the steps of:
filtering a simulated direct-sound first-channel signal to form a first-direct filtered signal;
filtering the simulated direct-sound first-channel signal to form a first-cross filtered signal;
filtering a simulated direct-sound second-channel signal to form a second-cross filtered signal;
filtering the simulated direct-sound second-channel signal to form a second-direct filtered signal;
forming a simulated early-reflection first-channel signal from the first-direct and second-cross filtered signals; and
forming a simulated early-reflection second-channel signal from the second-direct and first-cross filtered signals.

20. The medium of claim 19, wherein each filtering step comprises filtering the respective simulated direct-sound signal based on each simulated sound-reflecting object, and combining respective simulated direct-sound signals filtered according to simulated sound-reflecting objects to form the respective filtered signal.

21. The medium of claim 20, wherein at least one of the steps of filtering the respective simulated direct-sound signal based on each simulated sound-reflecting object comprises selectively amplifying and delaying the respective simulated direct-sound signal.

22. The medium of claim 21, wherein selectively amplifying the respective simulated direct-sound signal comprises conserving an energy of the respective simulated early-reflection signal.

23. The medium of claim 21, wherein at least one of the steps of filtering the respective simulated direct-sound signal based on each simulated sound-reflecting object further comprises applying a spectral shape that is common to the simulated sound-reflecting objects.

24. The medium of claim 19, further comprising the step of filtering a direct-sound signal according to first and second head-related transfer-functions, thereby forming the simulated direct-sound first- and second-channel signals.

25. The medium of claim 24, further comprising the steps of:
filtering the simulated direct-sound first- and second-channel signals with respective attenuation filters;
combining the simulated early-reflection first-channel signal with a filtered simulated direct-sound first-channel signal to form a first-channel output signal; and
combining the simulated early-reflection second-channel signal with a filtered simulated direct-sound second-channel signal to form a second-channel output signal.

26. The medium of claim 25, further comprising the steps of:
generating simulated late-reverberation first- and second-channel signals from the direct-sound signal;
combining the simulated late-reverberation first-channel signal with the first-channel output signal; and
combining the simulated late-reverberation second-channel signal with the second-channel output signal.
